(19) United States
(12) Patent Application Publication
(10) Pub. No.: US 2013/0198104 A1
(43) Pub. Date: Aug. 1, 2013

(54) SYSTEMS AND METHODS FOR MANAGING ELECTRONIC CONTRACTS AND DATA

(71) Applicant: Patricia S. Parker, Montrose, CA (US)

(72) Inventor: Patricia S. Parker, Montrose, CA (US)

(21) Appl. No.: 13/567,944

(22) Filed: Aug. 6, 2012

Related U.S. Application Data
(60) Provisional application No. 61/515,701, filed on Aug. 5, 2011.

(51) Int. Cl. G06Q 10/10

(52) U.S. Cl. CPC G06Q 10/10
USPC 705/342

(57) ABSTRACT

The present invention relates to systems and methods for managing electronic contracts and data. Specifically, the present invention relates to a computer system for generating and managing secondary contracts. The computer system may comprises a memory, a communication device operatively coupled to the memory to receive primary contract data from a secure document repository and at least one processor. The at least one processor may be operatively coupled to the communications device for extracting customer data from the primary contract and generating a secondary contract by populating a form contract with the customer data extracted from the primary contract; wherein the secondary contract is stored to the secure document repository and reconciled with data received from a third party to ensure data accuracy.

### CROSS-REFERENCE TO RELATED APPLICATIONS

The present application claims priority benefit of U.S. Patent Appln. No. 61/515,701, filed Aug. 5, 2011, the contents of which are incorporated herein by reference in their entirety.

### COMPUTER PROGRAM LISTING

This application includes the attached Computer Listing Appendix, hereby incorporated by reference. Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to systems and methods for managing electronic contracts and data. Specifically, the present invention relates to systems and methods for managing electronic contracts, invoices, and data for use in equipment bundling processes.

### BACKGROUND OF THE INVENTION

A majority of wireless interface and wireless users hold a cell phone contract with one or more service carriers. In its simplest form, a wireless interface or cell phone contract is a written legal agreement between the wireless user and the service carrier, whereby the carrier provides its service to the wireless user in exchange for an agreed-upon amount.

While contracts typically bind a user to a particular carrier for a set period of time, there are certain advantages to having a contract. Often, fewer limitations are placed on the use of the service and/or special deals that apply only to those that have a contract. For example, some carriers allow wireless users to place free calls to others with the same carrier. Other advantages include extended SMS options, such as, reduced-price or free text messaging services.

Some agents, dealers and carriers offer reduced or discounted cell phones and wireless interface equipment to customers in exchange for extended service contracts. In this type of deal, often referred to as bundling, the wireless user can afford a more expensive cell phones or equipment by agreeing to a longer service contract. Bundling such as this often requires two separate contracts, one for the service and another for the equipment.

However, it is becoming increasingly difficult to manage the numerous contracts, invoices, and data associated with bundling millions of wireless phone service and equipment contracts. Currently, most wireless agents, dealers and carriers encounter redundant manual data entry, wherein the same information must be entered into a primary service contract and a secondary equipment contract. In such situations, protocols must be in place to automate, verify, and correct any inaccuracies associated with the inputted customer data. Not surprisingly, such quality control measures can be quite costly to carriers and distributors, a cost which will eventually be passed onto the users.

A need exists for a system and method to efficiently and cost-effectively manage electronic primary and secondary contracts, invoices, and associated data for use in the cellular phone industry.

### SUMMARY OF THE INVENTION

The present invention addresses the need to cost-effectively manage electronic primary, secondary contracts, invoices and associated data for use in the wireless phone industry, more specifically, to manage data associated with equipment application and collection bundling processes.

In a first aspect, a computer-implemented method for generating and managing secondary contracts, comprises: receiving a primary contract from a secure document repository; extracting customer data from the primary contract; using a processor to generate a secondary contract by populating a form contract with the customer data extracted from the primary contract; and storing the secondary contract to the secure document repository; wherein data stored to the secure document repository is reconciled with data received from a third party to ensure data accuracy.

In a second aspect, a computer system for generating and managing secondary contracts, comprises: a memory; a communication device operatively coupled to the memory to receive primary contract data from a secure document repository; and at least one processor, operatively coupled to the communications device for extracting customer data from the primary contract and generating a secondary contract by populating a form contract with the customer data extracted from the primary contract; wherein the secondary contract is stored to the secure document repository and reconciled with data received from a third party to ensure data accuracy.

In a third aspect, a computer-implemented method for generating and managing contracts, comprises: receiving customer data from a secure document repository through a communication channel; using a processor to populate a contract with the customer data; and storing the contract to the secure document repository; wherein data stored to the secure document repository is reconciled with data received from a third party to ensure data accuracy.

In certain aspects, the computer-implemented method and/or computer system may be configured to prompt a user to provide additional customer data.

In another aspect, the primary contract is a service contract and the secondary contract is a equipment contract.

In another aspect, the processor organizes and displays the primary and secondary contracts in chart format via a display device.

In another aspect, the third party is a government agency.

In another aspect, a user interface device may be coupled to the processor to facilitate interaction with a user. The user interface device may includes at least one of the following: buttons; switches; a keyboard; a light pen; a mouse; a magnetic card reader; or a digitizer and a stylus.

### DESCRIPTION OF THE DRAWINGS

Embodiments of the present invention are illustrated by way of example, and not by limitation, in the figures of the accompanying drawings, in which like references indicate similar elements and in which:

FIG. 1 is a block diagram illustrating a exemplary system enabled to carry out the present intention;

FIG. 2 is a flow chart illustrating an exemplary method for generating a secondary contract;

FIG. 3 is a chart illustrating an exemplary format for displaying stored documents and data; and

FIG. 4 is a flow chart illustrating an exemplary method for eliminating incomplete and erroneous contracts.

### DETAILED DESCRIPTION OF THE PREFERRED EMBODIMENTS

The present invention is described herein with reference to one or more exemplary embodiments; however, it should be understood that the present invention is not limited to these embodiments. Those skilled in the art will appreciate that other arrangements, formulations and elements can be used instead and that some elements may be omitted altogether. In the following description, well-known functions or constructions may not be described extensively because they would obscure the invention in unnecessary detail.

Under an exemplary embodiment, the present invention relates to a computer-implemented process designed to manage electronic contracts, invoices, and data (herein referred to as a Chargeback Trak-R system™). The various features of a Chargeback Trak-R™ system will now be described in greater detail. For this application the following terms and definitions shall apply:

The terms “communicate” and “communicating”, as used herein, refer to both transmitting, or otherwise conveying, data from a source to a destination and delivering data to a communications medium, system, channel, network, device, wire, cable, fiber, circuit, and/or link to be conveyed to a destination.

The terms “contract”, and “agreement”, as used herein, each refer to a writing or document containing an agreement between two or more parties, including, but not limited to, service contracts, carrier contracts, and the like.

The terms “coupled”, “coupled to”, and “coupled with”, as used herein, each refer to a relationship between or among two or more devices, apparatus, files, circuits, elements, functions, operations, processes, programs, media, components, networks, systems, subsystems, and/or means, constituting any one or more of (i) a connection, whether direct or through one or more other devices, apparatus, files, circuits, elements, functions, operations, processes, programs, media, components, networks, systems, subsystems, or means; (ii) a communications relationship, whether direct or through one or more other devices, apparatus, files, circuits, elements, functions, operations, processes, programs, media, components, networks, systems, subsystems, or means; and/or (iii) a functional relationship in which the operation of any one or more devices, apparatus, files, circuits, elements, functions, operations, processes, programs, media, components, networks, systems, subsystems, or means depends, in whole or in part, on the operation of any one or more others thereof.

The term “database”, as used herein, refers to an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list, or in any other form.

The term “network”, as used herein, refers to both networks and inter-networks of all kinds, including the Internet, but is not limited to any particular network or inter-network.

The term “processor”, as used herein, refers to processing devices, apparatus, programs, circuits, components, systems, and subsystems, whether implemented in hardware, tangibly embodied software, or both, and whether or not programmable. The term “processor” as used herein includes, but is not limited to, one or more computers, hardwired circuits, signal modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

Generally speaking, Chargeback Trak-R™ system is an automated contract management system for electronic contracts and data designed to simplify and streamline the bundling process—a staple of the wireless industry. Chargeback Trak-R™ system's effective management of electronic contracts via invoices and data obtained from a primary contract (e.g., those of the wireless carrier) may be manipulated by a computer running Chargeback Trak-R™ system to systematically track secondary contracts and the collection process of delinquent contracts. Moreover, Chargeback Trak-R™ system enables a company to review and audit this automated information at their discretion, allowing for increased oversight and control of all company-generated contracts, charge-backs, and collections—resulting in increased customer compliance. Chargeback Trak-R™ system fulfills a present need of the wireless industry for a system that effectively and efficiently manages electronic primary and secondary contracts, particularly regarding equipment application and the collection bundling processes.

In some embodiments, Chargeback Trak-R™ system and methodology may increase the revenue generated by wireless retailers through its revolutionary process of simplifying and streamlining the bundling process that is common within the wireless industry. In some embodiments, a Chargeback Trak-R™ system automates the equipment bundling process, beginning at the point of sale through to the back end. A Chargeback Trak-R™ system may also generate an enforceable electronic secondary contract (e.g., an equipment contract) for customers while providing a single, integrated, secure document repository (e.g., a memory device) that may include contracts, invoices and letters and data associated with, for instance, carrier chargebacks, equipment contract compliance, and audit and review for a company.

In some embodiments, a Chargeback Trak-R™ system of the present invention can provide companies with increased oversight and control of all company-generated contracts, chargebacks, and collections, resulting in increased customer compliance, decreased equipment write-downs, and back office staff utilization. Chargeback Trak-R™ system functionality may be implemented via a processor-based system (e.g., a computer).

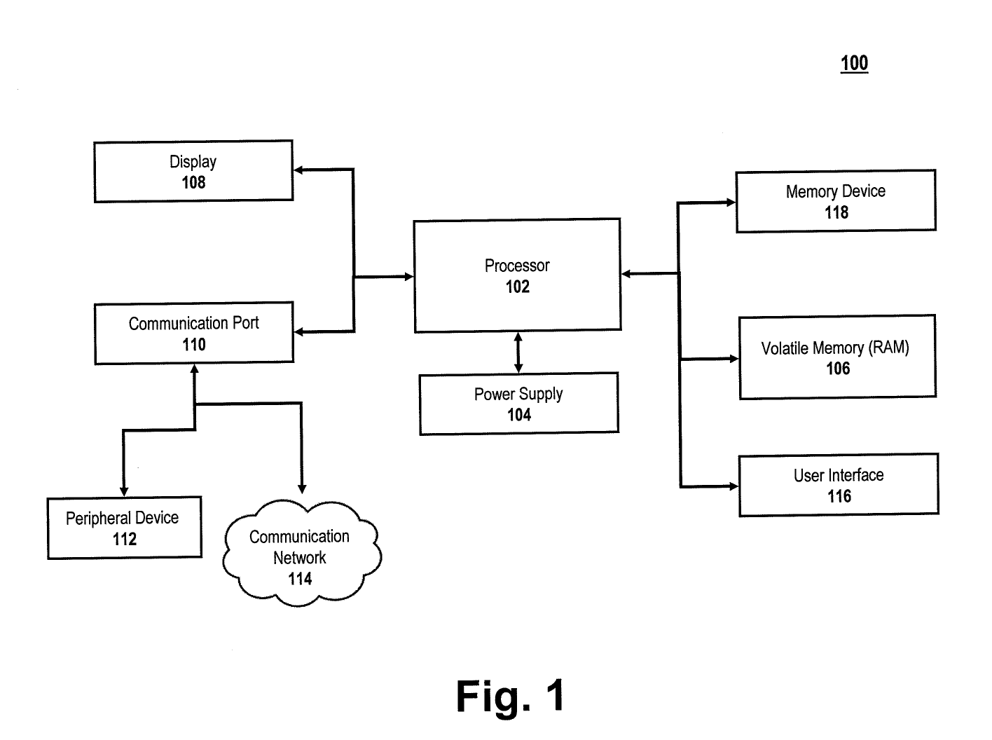

FIG. 1 depicts an exemplary processor-based system 100 enabled to carry out Chargeback Trak-R™ functionality. The system 100 may be any of a variety of devices such as a computer, pager, cellular phone, personal organizer, control circuit, etc. In a typical processor-based system, one or more processors 102, such as a microprocessor, control the processing of system functions and requests in the system 100. In certain embodiments, various existing processor-based devices may be modified merely by software and/or minor hardware changes to carry out Chargeback Trak-R™ functionality. The system 100 typically includes a power supply 104. For instance, if the system 100 is a portable system, the power supply 104 may advantageously include a fuel cell, permanent batteries, replaceable batteries, and/or rechargeable batteries. The power supply 104 may also include an AC adapter, allowing the system 100 to be plugged into a wall outlet, for instance. The power supply 104 may also include a DC adapter such that the system 110 may be plugged into a vehicle cigarette lighter, as another example.

Various other devices may be coupled to the processor 102 depending on the functions that the system 100 performs. To illustrate, a user interface device 116 may be coupled to the processor 102 and may include buttons, switches, a keyboard, a light pen, a mouse, a magnetic card reader/3-credit card reader (USB or Keyboard Wedge), a digitizer and a stylus (e.g., Topaz signature pad 4×3 LCD model, T-LBK755-HSB), a scanner, and/or a voice recognition system. A display 108 may also be coupled to the processor 102. The display 108 may include an LCD, an SED display, a CRT display, a DLP display, a plasma display, an OLED display, LEDs, and/or an audio display. One or more communication ports 110 may also be coupled to the processor 102. The communication port 110 may be adapted to be coupled, wired or wirelessly, to one or more peripheral devices 112 and preferably employs encryption techniques including, for example, Secure Sockets Layer (“SSL”) (e.g., 256-bit encryption) and/or Transport Layer Security (“TLS”) protocols. The one or more peripheral devices 112 may include, for example, a modem, printer, computer, or other auxiliary device. In certain embodiments, the communication port 110 may be enabled for communication, wired or wireless, with a communication network 114, such as a local area network, remote area network, intranet, or the Internet, for instance.

The processor 102 generally controls the system 100 by implementing software programs stored in the memory. For instance, the software may include software for carrying out Chargeback Trak-R™ functionality and/or an operating system, such as Windows XP, Windows Vista, Windows 7, Windows Server 2003, Mac OSX, Linux, etc. The memory device 118 is operably coupled to the processor 102 and may be used to store and facilitate execution of various programs, including Chargeback Trak-R™ functionality. For instance, the processor 102 may be coupled to the volatile memory 106 which may include Dynamic Random Access Memory (“DRAM”) and/or Static Random Access Memory (“SRAM”). The volatile memory 106 is typically large so that it can store dynamically loaded applications and data. As described further below, the volatile memory 106 may be configured in accordance with embodiments of the present invention.

The processor 102 may also be coupled to one or more memory devices 118. The memory device 118 may include a read-only memory (“ROM”), erasable programmable read-only memory (“EPROM”), flash memory and/or any other data storage device, which may be used in conjunction with the volatile memory 106. Similarly, depending on the system configuration, memory device 118 may spread data across one or more servers. The size of the ROM is typically selected to be just large enough to store any necessary operating system, application programs, and fixed data. Additionally, the non-volatile memory 118 may include a high-capacity memory such as a tape or disk drive memory (e.g., hard disk drive). In an embodiment of the invention, the memory device 118 may further include a separate data warehouse used to store data that is generally used less frequently (e.g., a data archive).

The memory device 118 and volatile memory 106 may store various types of software, such as an operating system or office productivity suite, including a word processing application, a spreadsheet application, an email application, and/or a database application. For example, in operation, the system would preferably be enabled to run ASP.NET 4.0 Framework Web servers (e.g., Internet Information Services (“IIS”) 5/6) and/or MS SQL Server 2005/2008 R2 Express Edition.

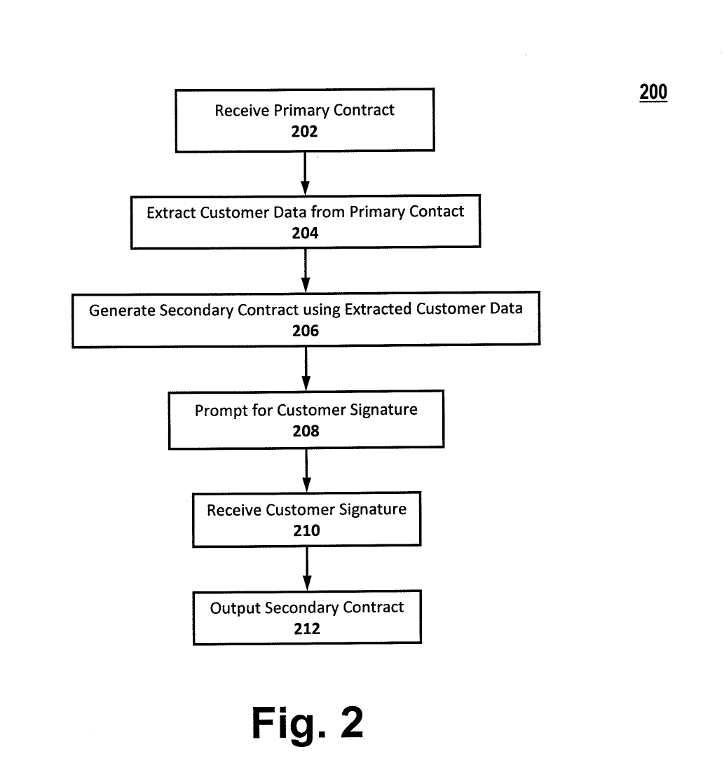

A Chargeback Trak-R™ system in accordance with the present invention provides a number of advantageous features. For example, a Chargeback Trak-R™ system may include contract authoring tools to enable the efficient and rapid creation of legally enforceable electronic customer contracts and functionality to facilitate internal contract reviews. An exemplary method 200 for generating a contract is provided in FIG. 2.

To generate a secondary contract, Chargeback Trak-R™ system may query a data repository (e.g., a memory device coupled with the processor) for customer data needed to complete the secondary contract. In addition to raw customer data, the memory device may comprise primary contracts and invoices. The primary contracts and invoices may be created either concurrently with the secondary contract or at a prior point in time. To the extent that customer data is not available, Chargeback Trak-R™ system may be further configured to permit a user to enter additional data at a point of entry or point of sale.

The primary contract is preferably received by the Chargeback Trak-R™ system electronically (e.g., entered through a user interface device at the point of sale), however hardcopy contracts may be readily received using, for example, a scanner and optical character recognition (OCR) techniques. Once the primary contract has been received by the system and/or stored to the memory device at step 202, the raw customer data may be extracted from the primary contract and stored to a memory device at step 204 (e.g., in tabular format, such as comma-separated values (CSV)). Such customer data may include, for example, the customer's full name, address, cellular number, home number, social security number, and any other information pertaining to the customer and account.

Chargeback Trak-R™ system may then use the customer data to generate a secondary contract at step 206. To facilitate secondary contract generation, a Chargeback Trak-R™ system may include one or more stored form contracts that permit population of the customer data by copying, or transferring, the stored customer data to one or more fields within the secondary contract. For instance, in bundling, if a customer has signed up for a service (e.g., via the primary contract) but now wishes to purchase a phone or other equipment (e.g., a transaction at a discounted rate), Chargeback Trak-R™ system can recall a form contract from memory that contains the appropriate terms and conditions (e.g., contractual provisions) of that type of transaction.

At step 206, upon secondary contract generation, a desired form contract may be selected from memory and automatically populated with the customer data, whether extracted or raw data. Specifically, the processor may determine the type of customer data needed and query the memory device for matching customer data (or raw date). If there is a match, the customer data may be copied from the memory device and inserted in the appropriate field of the form secondary contract. This process may continue until all of the form contract fields have been populated. For example, if the secondary contract has a field designated “customer address”, the processor may query the memory device to determine if there is a “customer address” data on file (e.g., via a primary contract or in raw data). To the extent that data is not available, the user may enter the missing data manually. Similarly, to the extent that there are errors or needed updates, such as a change of address, the user may have the option to edit the data extracted from the primary contract before finalizing the secondary contract.

Once the secondary contract has been generated at step 206, a Chargeback Trak-R™ system may prompt the customer for a signature at step 208. The prompt may be, for example, a window displayed on the screen of a stylus input device. Alternatively, if the customer has pre-approved the contract, a Chargeback Trak-R™ system may retrieve the customer's signature (e.g., as a digital image, file, or string of text) from memory and apply it to the secondary contract. Once a customer signature has been received at step 210 and saved to a memory device, a Chargeback Trak-R™ system may create a final, executed secondary contract. The Chargeback Trak-R™ system may then output the secondary contract to a database, printer and/or otherwise communicate it to the customer and/or carrier at step 212. For example, once a secondary contract has been created, it may be communicated to the secure document repository and stored with the primary contract received at step 202.

A secure document repository stored to a memory device may be used to form a database for storing and/or archiving contracts, data, and/or invoices for one or more customers. The secure document repository may be encrypted or employ other forms of security techniques. A benefit of extracting data from a contract and using the same data to generate a secondary contract is that customer data is consistent and correct and matches the data entered for the carrier contract, thereby ensuring accurate and complete secondary contracts.

As mentioned above, during contract execution, a Chargeback Trak-R™ system may receive a customer's signature, typically via a stylus input device, and electronically apply it to one or more contracts. The signature may also be stored to the system's database or another party's database for retrieval at a later date and/or for identification purposes. When the signature is applied to a contract, the contract may be generated as a password-protected or otherwise secured PDF. The contract may be printed at the point of sale for the customer's safekeeping, electronically communicated to the customer (e.g., via email or SMS text message) and/or stored to the system data storage (e.g., secure document repository).

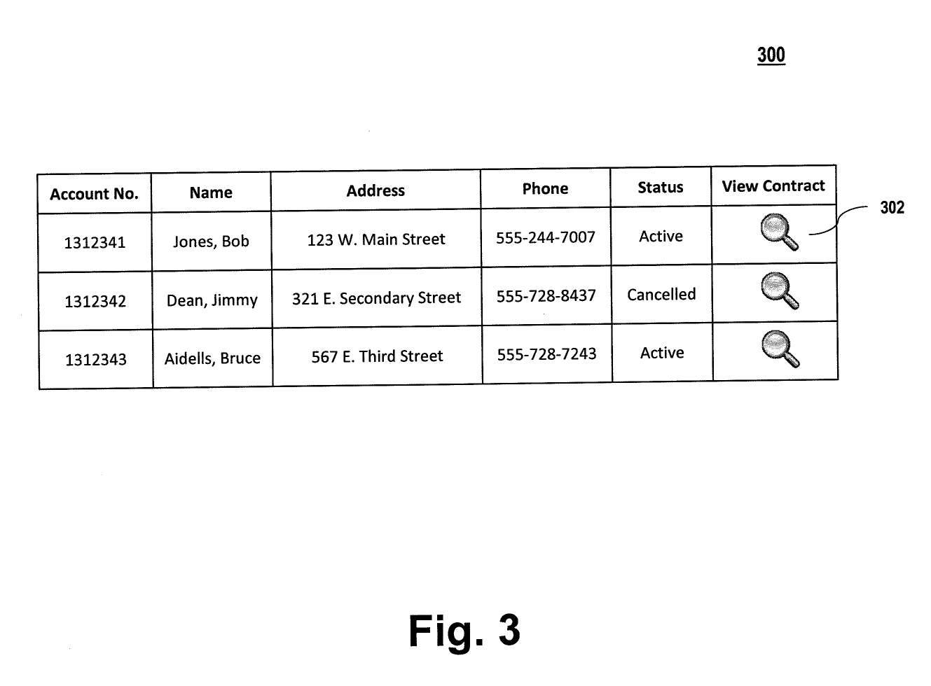

Under an embodiment, the extracted customer data for the various contracts and invoices may be organized and displayed in chart format allowing a user to easily view, organize, and locate customer information. The chart may be searchable and sortable (e.g., by field). An example chart 300 is depicted in FIG. 3. The chart 300 may present the customer information using one or more columns. In certain embodiments, a customer may wish to view the original document. To enable this functionality, a “View Contract” column may provide icons 302 that permit a user to select or view a contract (e.g., the full contract and/or terms). The contract may be displayed and/or downloaded as an image file (e.g., tiff, jpg, pdf, etc.). Extracting the data from the contracts allows for the user to easily generate reports and/or other documents. For example, management-generated reports may be compiled from the information stored to the secure document repository (aka, raw data), thereby enabling administration to proactively manage contracted commitments and obligations.

A notable benefit of a Chargeback Trak-R™ system is data reconciliation. In addition to ensuring that the secondary contract data matches the primary contract data, a Chargeback Trak-R™ system may reference third-party databases to ensure that stored customer data is accurate. For example, customer addresses may be verified with publicly available documents online (e.g., online address directories, white pages, yellow pages, government agencies, etc.). Similarly, customer data may be checked against other databases, including local databases, to ensure that the customer names, phone numbers, and other information are correct and consistent. A Chargeback Trak-R™ system may further eliminate errors by verifying that a credit card number is valid—simultaneously eliminating the need for credit card imprints. In this scenario, when the customer swipes his or her credit card (e.g., via a magnetic card reader, RFID reader, etc.), the customer information affiliated with the credit card may be checked against the contract customer data. If there are discrepancies, the retailer may be alerted and/or given the opportunity to correct the discrepancies.

As a result of the foregoing, a Chargeback Trak-R™ system offers a number of advantages from point of sale (e.g., the moment when the contract is created) through administration and reporting during a contract's life. For example, at the point of sale, a Chargeback Trak-R™ system reduces contract completion time for customers by automatically populating and error-checking data fields to eliminate incomplete and erroneous contracts.

A Chargeback Trak-R™ system offers a number of administrative advantages. For instance, a Chargeback Trak-R™ system can reduce the number of hours spent auditing contract completeness and accuracy because the data is verified as it is inputted by the carrier representative and cross-referenced against other forms of identification (e.g., driver's licenses, government IDs, credit cards, etc.). Because the data is electronically stored and organized, the number of hours spent in data collection and filing is reduced.

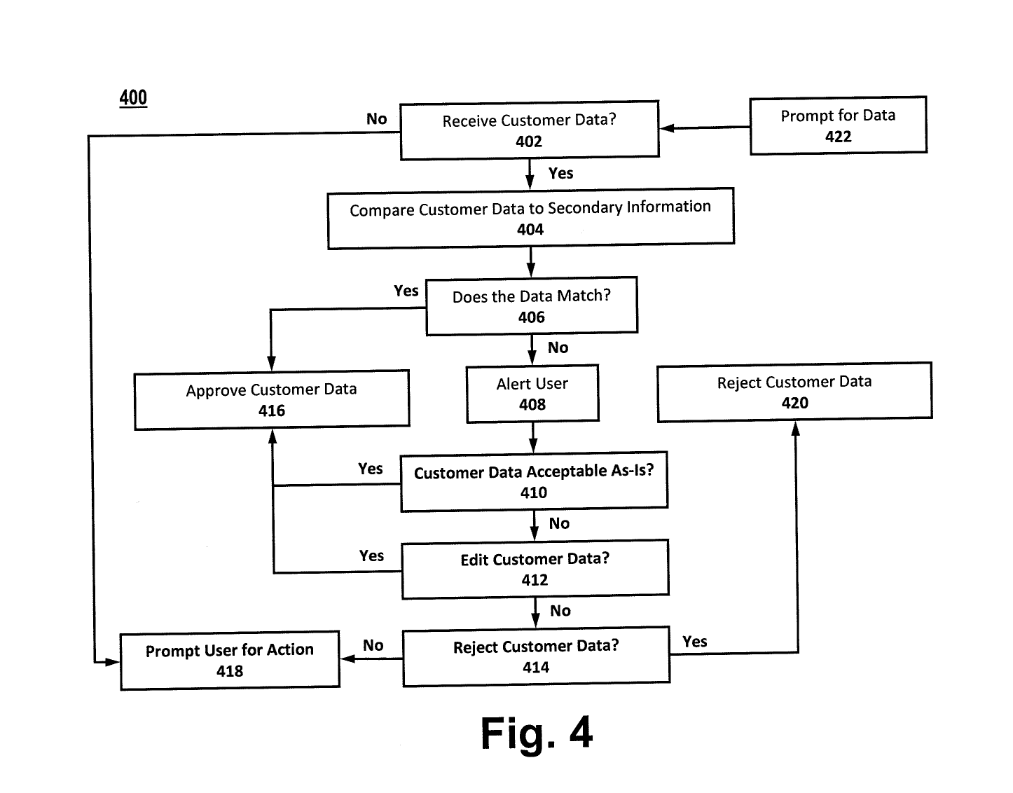

An exemplary method 400 for reducing or eliminating incomplete and erroneous contracts is provided in FIG. 4. While generating a secondary contract, a Chargeback Trak-R™ system may dynamically check customer data and data fields to ensure that all data fields are accurately populated. The secondary contract may be checked after each data field has been populated/addressed or after all available customer data has been supplied. For example, if data is missing, Chargeback Trak-R™ system may prompt the user or customer to provide the missing customer data at step 422. The data may be manually entered by the user (or customer) or automatically extracted from a primary contract or database. In either instance, if a data field is not populated (e.g. left blank) at step 402, the user (or customer) may be prompted to take action at step 418. In this scenario, the user may provide the missing customer data or provide approval to leave the section blank (e.g., physically leaving it blank or entering “non-applicable”).

If Chargeback Trak-R™ system receives customer data at step 402, a computer processor may compare customer data to one or more pieces of secondary information at step 404. Secondary information may be obtained and/or copied from, for example, publicly available documents (e.g., online address directories, white pages, yellow pages, government agencies, etc.), data associated with the customer's credit card, government agencies, or any other database in communication with a Chargeback Trak-R system™. At step 406, using a processor, Chargeback Trak-R™ system may determine whether the received customer data matches the secondary information. A Chargeback Trak-R™ system may employ a variety of matching techniques, ranging from requiring an identical match, to only requiring only a substantial match (e.g., meeting a preset match percentage, aka “fuzzy match”, using a computer algorithm). For example, if a name is inputted as “John Smith”, but records often show him as “Jonathan Smith”, it may be advantageous to simply accept this as a substantial match to avoid unwanted delays. If a Chargeback Trak-R™ system determines that there is a match, the customer data may be approved at step 416 thereby indicating that the customer data has been verified and found to be accurate.

On the other hand, Chargeback Trak-R™ system may determine that the received customer data does not match the secondary information at step 406. The user may then be notified at step 408 of the abnormality via a visual display (e.g., a window or screen), text message, email, and/or auditory alert. The notification may also provide the details of the abnormality, including, for example, the customer data received, the data it was compared to and/or any discrepancies. From this point, at step 420, the user may accept the customer data as-received thereby causing the customer data to be approved at step 416. Alternatively, the user may deny the customer data at step 410, electing to edit the customer data at step 412. Via a user interface coupled to a processor based computer with data storage having Chargeback Trak-R™ system stored thereon, the customer data may be (i) manually edited (e.g., the user can use a user interface to change the data), (ii) automatically replaced with the secondary information if the secondary information source is considered reliable/trustworthy, or (iii) combinations thereof. Otherwise, a Chargeback Trak-R™ system may consider rejecting the customer data at step 414.

In this situation, a Chargeback Trak-R™ system may prompt the user or customer to take action. The user may, for example, provide the correct customer data or provide approval to leave the section as-is. Alternatively, the customer data may be deemed rejected at step 414 thereby causing a Chargeback Trak-R™ system to reject the customer data.

Additionally, a Chargeback Trak-R™ system may eliminate duplication of key stroke entries by automatically populating form invoices generated by retail management software. An exemplary retail management software system includes RQ4, available from iQmetrix at http://www.iqmetrix.com/. RQ4 provides features for managing and streamlining the core functions of a business, such as point of sale, customer relationship management (“CRM”), inventory management, human resources, and accounting.

Other benefits of a Chargeback Trak-R™ system include, for example, (i) increased merchant bank acceptance of charges resulting from contract authentication, (ii) reduction in referrals to collection agencies, (iii) reduction in collection agency denials due to incomplete, missing, or erroneous customer information, (iv) elimination of liability of physical storage of contracts and customer credit card information, and (v) role-based user creation and management.

A Chargeback Trak-R™ system also provides numerous benefits when reporting information. For instance, with respect to chargeback and batch reporting, reconciliation with carrier chargebacks increases efficiency as it may provide (i) a list of contracts by invoice number; (ii) returns reporting; (iii) check versus credit card monitoring; and (iv) expiring contracts and (v) expiring credit cards.

A Chargeback Trak-R™ system may also increase efficiency by providing linking functionality to bundled contracts and providing reports in response to cancellation data received from the carrier. For example, if a user has bundled a hardware contract with a carrier service contract, there will likely be a fee associated with one or both of the contracts if there is an early termination of, for instance, the carrier contract. In this scenario, the customer will likely have to pay a fee on the hardware contract upon cancelation of the carrier contract. A Chargeback Trak-R™ system can eliminate the need to manually check the contracts against one another by, for instance, generating a report of all contracts impacted by a cancelation. The user may then use this report to promptly contact and/or charge the affected customers or other party.

Although various embodiments have been described with reference to a particular arrangement of parts, features, and the like, these are not intended to exhaust all possible arrangements or features, and indeed many other embodiments, modifications, and variations will be ascertainable to those of skill in the art.

All U.S. and foreign patent documents, and all articles, brochures, and all other published documents discussed above are hereby incorporated by reference into the Detailed Description.

What is claimed is:

1. A computer-implemented method for generating and managing secondary contracts, comprising:
receiving a primary contract from a secure document repository;
extracting customer data from the primary contract;
using a processor to generate a secondary contract by populating a form contract with the customer data extracted from the primary contract; and
storing the secondary contract to the secure document repository; wherein data stored to the secure document repository is reconciled with data received from a third party to ensure data accuracy.

2. The computer-implemented method of claim 1, further comprising the step of:
prompting a user to provide additional customer data.

3. The computer-implemented method of claim 1, wherein the primary contract is a service contract and the secondary contract is a equipment contract.

4. The computer-implemented method of claim 1, wherein the processor organizes and displays the primary and secondary contracts in chart format via a display device.

5. The computer-implemented method of claim 1, wherein the third party is a government agency.

6. The computer-implemented method of claim 1, wherein a user interface device is coupled to the processor to facilitate interaction with a user.

7. The computer-implemented method of claim 6, wherein the user interface device includes at least one of the following: buttons; switches; a keyboard; a light pen; a mouse; a magnetic card reader; or a digitizer and a stylus.

8. A computer system for generating and managing secondary contracts, comprising:
a memory;
a communication device operatively coupled to the memory to receive primary contract data from a secure document repository; and
at least one processor, operatively coupled to the communications device for extracting customer data from the primary contract and generating a secondary contract by populating a form contract with the customer data extracted from the primary contract; wherein the secondary contract is stored to the secure document repository and reconciled with data received from a third party to ensure data accuracy.

9. The computer system of claim 8, wherein the processor is configured to a user to request additional customer data from a user.

10. The computer system of claim 8, wherein the primary contract is a service contract and the secondary contract is a equipment contract.

11. The computer system of claim 8, wherein the primary and secondary contracts are organized and displayed in chart format.

12. The computer system of claim 8, wherein the third party is a government agency.

13. The computer system of claim 8, further comprising a user interface device for facilitating interaction with a user.

14. The computer system of claim 13, wherein the user interface device includes at least one of the following: buttons; switches; a keyboard; a light pen; a mouse; a magnetic card reader; or a digitizer and a stylus.

15. A computer-implemented method for generating and managing contracts, comprising:
receiving first customer data from a secure document repository through a communication channel;
receiving second customer data from a user via a user interface device;
using a processor to populate a contract with the first and second customer data according to a predetermine algorithm; and
storing the contract to the secure document repository;
wherein data stored to the secure document repository is reconciled with data received from a third party to ensure data accuracy.

16. The computer-implemented method of claim 15, further comprising the step of:
prompting a user to provide additional customer data.

17. The computer-implemented method of claim 15, wherein the primary contract is a service contract and the secondary contract is a equipment contract.

18. The computer-implemented method of claim 15, wherein the processor organizes and displays the primary and secondary contracts in chart format via a display device.

19. The computer-implemented method of claim 15, wherein the third party is a government agency.

20. The computer-implemented method of claim 15, wherein the user interface device includes at least one of the following: buttons; switches; a keyboard; a light pen; a mouse; a magnetic card reader; or a digitizer and a stylus.
